(19) United States
(12) Patent Application Publication
(10) Pub. No.: US 2012/0172094 A1
(43) Pub. Date: Jul. 5, 2012

(54) Mobile Communication Apparatus

(75) Inventors: Che-Hung Lin, Taipei (TW); Tien-Peng Yu, Taipei (TW)

(73) Assignee: PEGATRON CORPORATION, Taipei (TW)

(21) Appl. No.: 13/339,453

(22) Filed: Dec. 29, 2011

(30) Foreign Application Priority Data
Dec. 31, 2010 (TW) 099225807

(51) Int. Cl. H04W 88/00

(52) U.S. Cl. 455/570

(57) ABSTRACT

A mobile communication apparatus is provided. The mobile communication apparatus includes a speaker, a sound receiving unit, an audio signal processing unit, and a control unit. The sound receiving unit provides an audio signal based on external sounds. The audio signal processing unit is connected to the speaker and the sound receiving unit to receive the first audio signal from the sound receiving unit and output a coded audio signal to the speaker. The control unit is connected to the audio signal processing unit and provides a control signal, wherein the control signal corresponds to a pre-determined mode. The control unit controls the audio signal processing unit to stop outputting the first audio signal to the speaker based on a first control signal.

### BACKGROUND OF THE INVENTION

1. Field of the Invention

This invention relates to a mobile communication apparatus, specifically to a mobile communication apparatus that can block audio signals received by the sound receiving device from reaching the speaker.

2. Description of the Prior Art

Normally during voice communication through mobile phones, the user's voice is transmitted not only to the corresponding party but also to the speaker of the user's mobile phone where the user's voice is often mixed with the voice from the corresponding party. In this way, the user may hear both his/her own voice and the voice from the corresponding party.

However, in specific environments such as a noisy place or an enclosed space, the above-mentioned practice of mixing of voices may make it impossible for the user to recognize what the corresponding party trying to say due to the mixed voices.

Various technologies are developed to solve the problem mentioned above. For instance, possible solutions include a microphone array that uses two microphones to receive sound and provide two corresponding audio signals. A digital signal processor is then used to compare these two audio signals in order to eliminate the ambient noise and keep only the voice from the corresponding party. However, the use of microphone array and digital signal processor will also increase the overall cost. On the other hand, a noise database should be established to provide references for the digital signal processor to compare audio signals. However, such an approach also requires the corresponding party to install a microphone array in order to achieve better results.

Crystal talk is another commonly used solution where the digital signal processor uses software to compare the sound received with the ambient noise in order to eliminate the ambient noise and keep only the voice from the corresponding party. However, this practice cannot achieve satisfactory results in an enclosed environment and excessive ambient noise may raise the overall sound volume provided by the speaker, causing hearing damage over long-term use.

Furthermore, signal analysis using software often requires the signal to be as linear as possible. However, in an enclosed space, the sound may be subjected to irregular reflections by the environment and create non-linear noises. This shows that the conventional technology is subjected to environment restraint and thus cannot achieve satisfactory noise reduction effect.

### SUMMARY

It is an object of the present invention to provide a mobile communication apparatus. The mobile communication apparatus of the present invention uses a simpler and more cost-effective way to provide clear and easily recognizable sounds.

The mobile communication apparatus of the present invention includes a speaker, a sound receiving unit, an audio signal processing unit, and a control unit. The sound receiving unit provides a first audio signal based on external sounds. The audio signal processing unit is connected to the speaker and the sound receiving unit to receive the first audio signal from the sound receiving unit and output a coded audio signal to the speaker. The control unit is connected to the audio signal processing unit and provides a first control signal, wherein the first control signal corresponds to a pre-determined mode. The control unit controls the audio signal processing unit to stop outputting the first audio signal to the speaker based on the first control signal.

The embodiment of the present invention makes the sound provided by the speaker clearer and more recognizable by stopping the sound receiving device from outputting audio signals to the speaker.

### BRIEF DESCRIPTION OF THE DRAWINGS

FIG. 1 is a schematic view of the mobile communication apparatus in the first embodiment of the present invention;

FIG. 2 is a schematic view of a variation of the mobile communication apparatus shown in FIG. 1;

FIG. 3 is a schematic view of the mobile communication apparatus in the second embodiment of the present invention;

FIG. 4 is a schematic view of the on-screen display of the mobile communication in embodiments of the present invention; and

FIG. 5 is a schematic view of the mobile communication apparatus in the third embodiment of the present invention.

### DETAILED DESCRIPTION OF THE PREFERRED EMBODIMENT

The embodiment of the present invention provides a mobile communication apparatus. In preferred embodiments, the mobile communication apparatus may includes mobile phones, personal digital assistant (PDA), and electronic devices with mobile communication functionality.

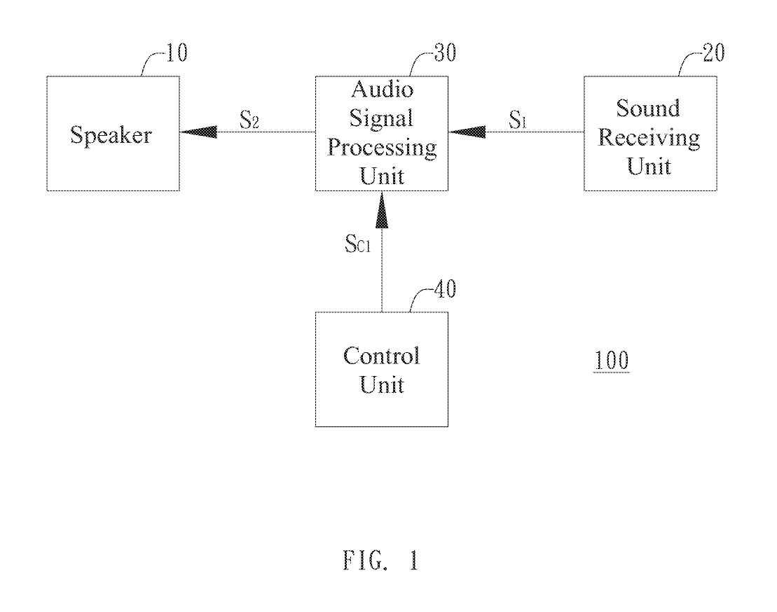

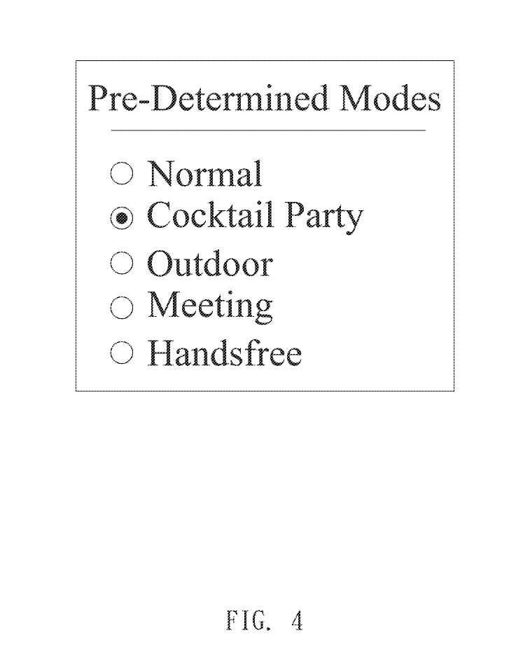

FIG. 1 is a schematic view of the mobile communication apparatus 100 in the first embodiment of the present invention. The mobile communication apparatus 100 has a plurality of pre-determined modes as shown in FIG. 4. In the present embodiment, the mobile communication apparatus 100 is a mobile phone, wherein the pre-determined modes are the usage scenarios of the mobile phone. In a preferred embodiment, the pre-determined modes include a cocktail party mode suitable for noisy environment. Please refer to FIG. 1, the mobile communication apparatus 100 includes a speaker 10, a sound receiving unit 20, an audio signal processing unit 30, and a control unit 40.

The speaker 10 is preferably the speaker of the mobile phone. The sound receiving unit 20 provides a first audio signal S₁ based on external sounds, wherein the external sounds include the user's voice and other ambient sounds. The audio signal processing unit 30 is connected to the speaker 10 and the sound receiving unit 20 to establish a signal connection between the speaker 10 and the sound receiving unit 20. The audio signal processing unit 30 receives the first audio signal S₁ and outputs a coded audio signal S₂ to the speaker 10. The control unit 40 is connected to the audio signal processing unit 30 and provides a first control signal S_{c1}. In the present embodiment, the control signal S_{c1} corresponds to the cocktail party mode mentioned above. The control unit 40 controls the audio signal processing unit 30 to selectively stop the coded audio signal S₂ to the speaker 10. In the present embodiment, upon receiving the first control signal S_{c1}, the audio signal processing unit 30 will stop the signal connection between the speaker 10 and the sound receiving unit 20. In other words, the control unit 40 will control the audio signal processing unit 30 to stop outputting the coded audio signal S₂ to the speaker 10 when the pre-determined mode is set at the cocktail party mode, but is not limited thereto. In different embodiments, the control unit 40 may restrict the audio signal processing unit 30 from outputting the coded audio signal S₂ to the speaker 10 when the pre-determined mode is set at other modes.

In a preferred embodiment, the control unit 40 is a central processing unit (CPU). However, in different embodiments, the control unit 40 may be other electronic devices with control function, such as a digital signal processor or a microcontroller. The present invention uses the control unit 40 and software to block the audio signal from the sound receiving unit 20 to the speaker 10. Compared with the existing technology, the embodiment of the present invention uses an easy and low-cost way to make the sound provided by the speaker 10 of the embodiment clear and easily recognizable to the listener. In addition, related software may be embedded into hardware devices such as an application-specific integrated circuit (ASIC) or a programmable logic device (PLD), in the form of a firmware.

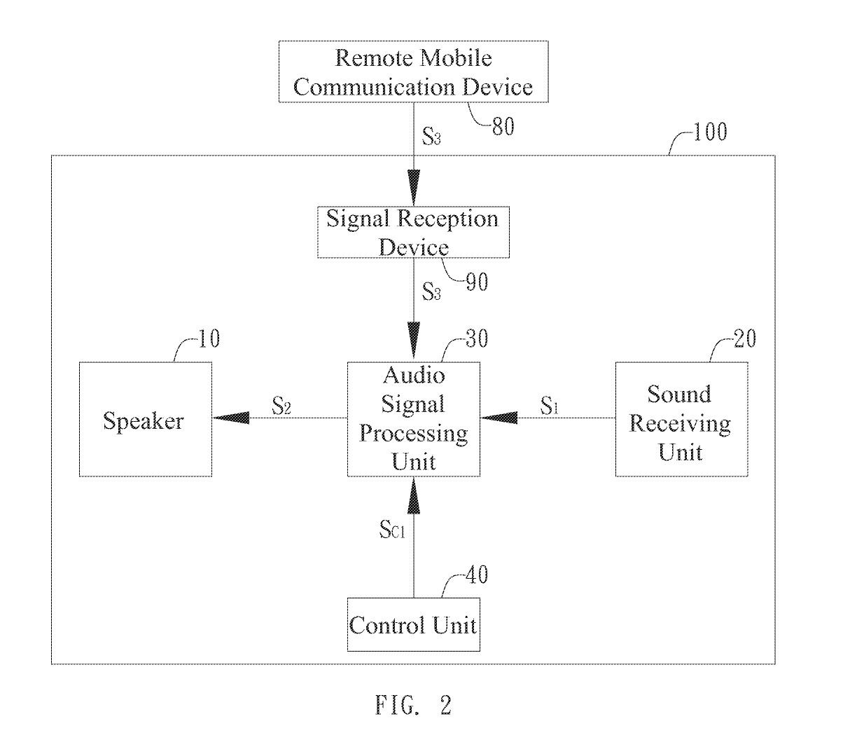

FIG. 2 is a schematic view of a variation of the mobile communication apparatus 100 shown in FIG. 1, wherein the mobile communication device 100 of the present embodiment establishes a signal connection with a remote mobile communication device 80 for users to chat with voice. As FIG. 2 shows, the mobile communication apparatus 100 includes a signal reception device 90 used to establish the signal connection with the remote mobile communication device 80 and receive a second audio signal S₃, wherein the second audio signal S3 is preferably provided by the user of the remote mobile communication 80, but is not limited thereto. In other embodiments of the present invention, the mobile communication apparatus 100 may receive the second audio signal S₃ from a personal computer or other electronic devices by wireless transmission methods, such as the global system for mobile communication GSM, or wired transmission methods, wherein the second audio signal S₃ may be digital music signals or electrical signals with audio content.

In the embodiment shown in FIG. 2, the signal reception device 90 of the mobile communication apparatus 100 of the present invention transmits the second audio signal S₃ to the audio signal processing unit 30. The audio signal processing unit 30 outputs the coded audio signal S₂ to the speaker 10 based on the first audio signal S₁ and the second audio signal S₃. However, the audio signal processing unit 30 will cut off the signal connection between the speaker 10 and the sound receiving unit 20 after receiving a first control signal S_{c} Therefore, upon receiving the control signal S_{c}, the audio signal processing unit 30 will output the coded audio signal S₂ to the speaker 10 based only on the second audio signal S₃.

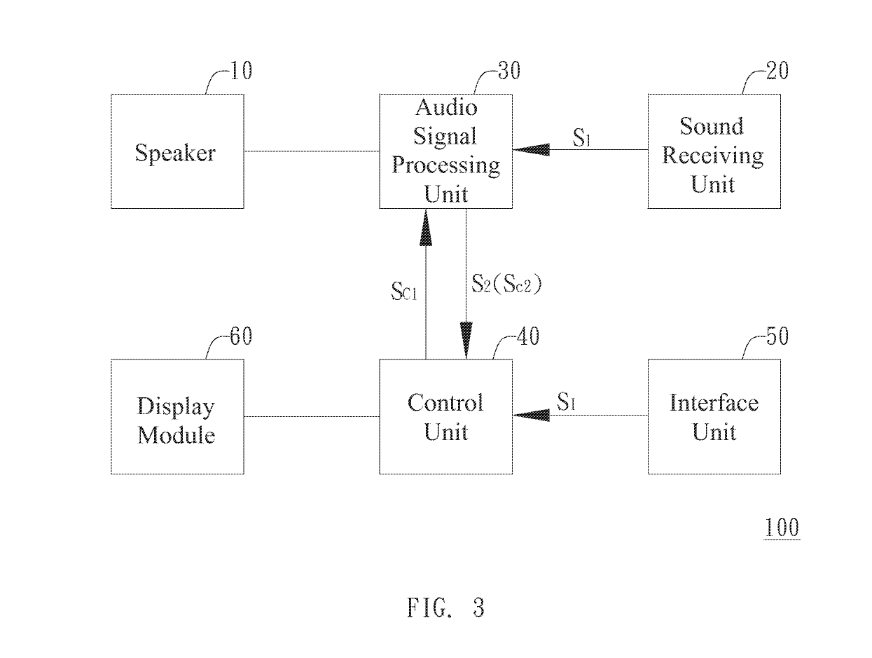

The operation of the control unit 40 may be controlled by other devices. FIG. 3 is a schematic view of the mobile communication apparatus 100 in the second embodiment of the present invention. As FIG. 3 shows, in addition to elements such as the speaker 10, the sound receiving unit 20, the audio signal processing unit 30, and the control unit 40 mentioned above, the mobile communication apparatus 100 further includes an interface unit 50 and a display module 60. The interface unit 50 is connected to the control unit 40 to transmit an interface signal S_{I} to the control unit 40, so that the control unit 40 may provide a first control signal S_{c1} based on the interface signal S_{I}. In the present embodiment, the interface unit 50 includes a touch-sensing module connected to the control unit 40 and configured to transmit the interface signal S_{I} to the control unit 40, wherein the control unit 40 provides a first control signal S_{c1} based on the interface signal S_{I}. However, in other embodiments, the interface unit 50 may includes a keyboard connected to the control unit 40 and configured to transmit the interface signal S_{I} to the control unit 40, wherein the control unit 40 provides the first control signal S_{c1} based on the interface signal S_{I}. In a preferred embodiment, the interface unit 50 may be used to switch between pre-determined modes during conversation in order to cope with the ambient sounds in a noisy environment.

Furthermore, the mobile communication apparatus 100 may use a voice action received by the sound receiving unit 20 to stop audio signal processing unit 30 from outputting audio signals to the speaker 10. The audio signal processing unit 30 receives the first audio signal S₁ including the voice action and provides the coded audio signal S₂ including a second control signal S_{c2} to the control unit 40. The control unit 40 then provides a first control signal S_{c1} based on the second control signal S_{c2} to control the audio signal processing unit 30 to stop the signal connection between the speaker 10 and the sound receiving unit 20. The display module 60 is connected to the control unit 40 and may provide the on-screen display with the pre-determined mode options shown in FIG. 4, wherein users may control the interface unit 50 based on the on-screen display to transmit an interface signal S_{I} to the control unit 40, so that the control unit 40 may provide a first control signal S_{c1} after receiving the interface signal S_{I}. In a preferred embodiment, the content of the second control signal S_{c2} includes the voice action used for setting the pre-determined mode and the voice action can be the user's voice received by the sound receiving unit 20.

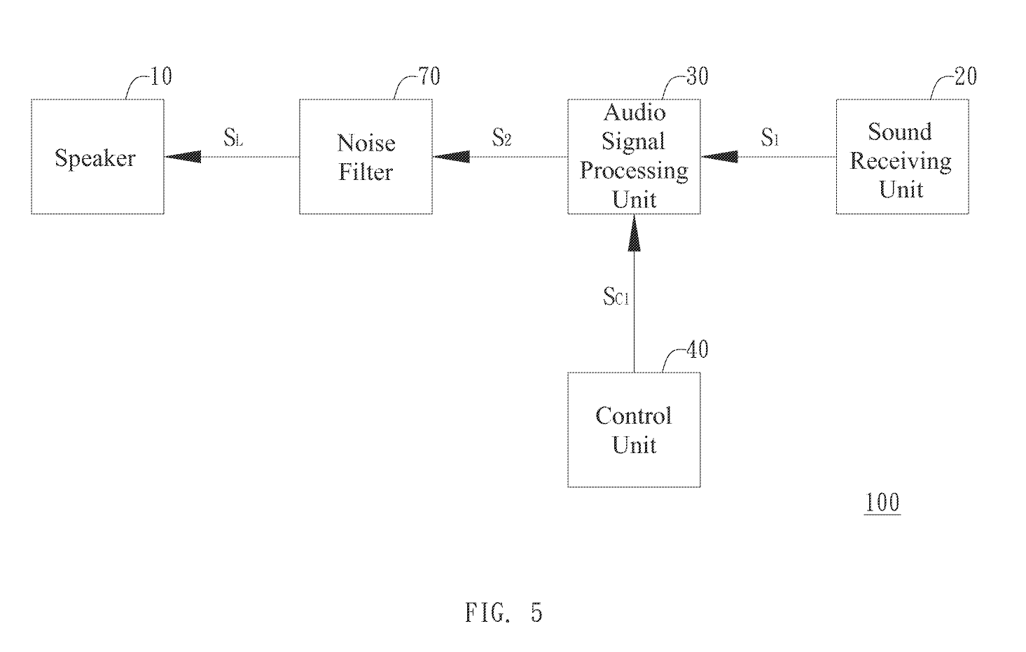

FIG. 5 is a schematic view of the mobile communication apparatus 100 in the third embodiment of the present invention. Please refer to FIG. 5, in addition to elements such as the speaker 10, the sound receiving unit 20, the audio signal processing unit 30, and the control unit 40 mentioned above, the mobile communication apparatus 100 further includes a noise filter 70. The noise filter 70 receives the coded audio signal S₂ from the audio signal processing unit 30 and then transmits a low-noise signal S_{L} to the speaker 10. In the present embodiment, the noise filter 70 is a digital signal processor used to reduce ambient noises and provides the low-noise signal S_{L} that corresponds closest to the original sound. However, in different embodiments, other electronic devices with noise filtering function may also be used to provide the low-noise signal S_{L} that is closest to the original sound.

The above is detailed descriptions of the particular embodiments of the invention which is not intended to limit the invention to the embodiments described. It is recognized that modifications within the scope of the invention will occur to a person skilled in the art. Such modifications and equivalents of the invention are intended for inclusion within the scope of this invention.

What is claimed is:

1. A mobile communication apparatus capable of operating in a pre-determined mode, the mobile communication apparatus comprising:
a speaker;
a sound receiving unit for providing a first audio signal based on external sounds;
an audio signal processing unit, connected to the speaker and the sound receiving unit, the audio signal processing unit receiving the audio signal from the sound receiving unit and outputting the coded audio signal to the speaker;
a control unit, connected to the audio signal processing unit, the control unit generating a control signal corresponds to the pre-determined mode and controlling the audio signal processing unit to stop outputting the first audio signal to the speaker based on the first control signal.

2. The mobile communication apparatus of claim 1, wherein the audio signal processing unit receives a second audio signal and outputting coded audio signal to the speaker under the pre-determined mode.

3. The mobile communication apparatus of claim 2, wherein the second audio signal is provided by a remote mobile communication device.

4. The mobile communication apparatus of claim 1, further including an interface unit, connected to the control unit, transmitting an interface signal to the control unit, so that the control unit generating the control signal based on the interface signal to stop the audio signal processing unit from outputting the coded audio signal.

5. The mobile communication apparatus of claim 4, wherein the interface unit includes a touch-sensing module connected to the control unit.

6. The mobile communication apparatus of claim 1, further including a noise filter connected between the speaker and the audio signal processing unit, the noise filter receiving the coded audio signal from the audio signal processing unit and transmitting a low-noise signal to the speaker.
